(19) United States
(12) Patent Application Publication
(10) Pub. No.: US 2014/0265908 A1
(43) Pub. Date: Sep. 18, 2014

(54) CIRCUITS AND METHODS FOR DRIVING LIGHT SOURCES

(71) Applicant: O2Micro Inc., Santa Clara, CA (US)

(72) Inventors: Xinhe SU, Sichuan (CN); Xiang GENG, Sichuan (CN)

(73) Assignee: O2Micro Inc., Santa Clara, CA (US)

(21) Appl. No.: 14/092,079

(22) Filed: Nov. 27, 2013

Related U.S. Application Data
(63) Continuation-in-part of application No. 13/851,681, filed on Mar. 27, 2013.

(30) Foreign Application Priority Data
Mar. 14, 2013 (CN) 201310080780.0
Oct. 18, 2013 (CN) 201310491370.5

(51) Int. Cl. H05B 37/02

(52) U.S. Cl. CPC H05B 37/02
USPC 315/224

(57) ABSTRACT

A circuit includes a converter and a controller. The converter includes a switch which is turned on and off alternately according to a driving signal to control a current. The controller generates the driving signal which is a periodic signal having a first state in a first time duration and having a second state in a second time duration and in a third time duration per period of the driving signal. The controller modulates the first time duration and the second time duration to have a change rate, and modulates the third time duration equal to a product of the change rate and a sum of the first time duration and the second time duration, such that a quotient of the first time duration squared and the period of the driving signal is independent of a change of the first time duration, and the current is independent of the change.

### RELATED APPLICATIONS

This application is a continuation-in-part of the co-pending U.S. patent application Ser. No. 13/851,681, titled “Circuits and Methods for Driving Light Sources”, filed on Mar. 27, 2013, which claims priority to Chinese Patent Application No. 201310080780.0, titled “Circuits and Methods for Driving Light Sources”, filed on Mar. 14, 2013, with the State Intellectual Property Office of the People's Republic of China, and this application also claims priority to Chinese Patent Application No. 201310491370.5, titled “Circuits and Methods for Driving Light Sources”, filed on Oct. 18, 2013, with the State Intellectual Property Office of the People's Republic of China, all of which are fully incorporated herein by reference.

### BACKGROUND

Electromagnetic interference (EMI) is a disturbance that interrupts, obstructs, or otherwise degrades or limits the effective performance of a circuit. Electromagnetic compatibility (EMC) is intended to ensure that circuits will not interfere with or prevent each other's operation because of EMI absorption.

A driving circuit for a light-emitting diode (LED) light source usually includes a converter for receiving an alternating-current input voltage from the grid and for generating a direct-current output voltage to drive the LED source. The converter turns a switch on and off according to a pulse-width-modulation (PWM) signal, such that the LED source is powered and the dimming controlled. However, because of the on and off operation of the switch, the current through the LED source is periodic and non-sinusoidal, composed of a sinusoidal current of a fundamental frequency and multiple sinusoidal currents of harmonic frequencies in a spectrum analysis. A harmonic frequency is an integral multiple of a fundamental frequency, for example, the secondary harmonic frequency of a fundamental frequency 50 Hz is 100 Hz, and the third harmonic frequency is 150 Hz. Thus, the current flowing through the LED source may further comprise a secondary harmonic, a third harmonic, and even more upper-harmonics. By either electromagnetic induction or radiation, the harmonic currents will enter other light-current systems (such as video systems or audio systems) in the same grid and interrupt their operations. Therefore, a conventional driving circuit for the LED light source has relatively poor EMC.

Switching frequency modulation is a conventional method to reduce EMI (see “Reduction of Power Supply EMI Emission by Switching Frequency Modulation”, IEEE Transactions on Power Electronics, Vol. 9, No. 1, January 1994, by Feng Lin, Member, IEEE, and Dan Y. Chen, Senior Member, IEEE). The converter creates side-bands by modulating the switching frequency, and thus the radiation characteristics of the harmonic currents are converted from a narrow-band noise to a broad-band noise. For example, by modulating the switching frequency in a preset range regularly or randomly, the noise energy is distributed into smaller pieces scattered around side-band frequencies, such that a peak current at the harmonic frequency is attenuated effectively. Thus, EMI is reduced. However, the LED current changes as the switching frequency changes, which will cause the LED light source to flicker. Therefore, the LED light source has poor current stability.

### SUMMARY

Embodiments according to the present invention provide a circuit including a converter and a controller. The converter provides an output voltage to power a light source, and includes a switch which is turned on and off alternately according to a driving signal to control a current through the light source. The controller generates the driving signal, which is a periodic signal having a first state in a first time duration and having a second state in a second time duration and in a third time duration per period of the driving signal. The switch is turned on when the driving signal operates in the first state and is turned off when the driving signal operates in the second state. The controller modulates the first time duration and the second time duration to have a first change rate, and modulates the third time duration equal to a product of the first change rate and a sum of the first time duration and the second time duration, such that a quotient of the first time duration squared and the period of the driving signal is independent of a change of the first time duration (that is, a change in the length of first time duration), and the current is independent of the change.

Embodiments according to the present invention also provide a controller for controlling current to a light source. The controller includes a signal generator and an output circuit. The signal generator generates a ramp signal and a control signal. The output circuit generates a driving signal according to the ramp signal and the control signal. The driving signal is a periodic signal having a first state in a first time duration and having a second state in a second time duration and in a third time duration per period of the driving signal. A switch coupled to the controller is turned on when the driving signal operates in the first state and turned off when the driving signal operates in the second state to control a current through the light source. The controller modulates the first time duration and the second time duration to have a first change rate, and modulates the third time duration equal to a product of the first change rate and a sum of the first time duration and the second time duration, such that a quotient of the first time duration squared and the period of the driving signal is independent of a change of the first time duration, and the current is independent of the change.

Embodiments according to the present invention also provide a method. The method includes: converting an input voltage to an output voltage based on a conductance status of a switch to power a light source; generating a driving signal to control the conductance status of the switch on and off alternately to control a current through the light source, wherein the driving signal is a periodic signal having a first state in a first time duration and having a second state in a second time duration and in a third time duration per period of the driving signal, wherein the switch is turned on when the driving signal operates in said first state, and is turned off when the driving signal operates in said second state; modulating the first time duration and the second time duration to have a first change rate; and modulating the third time duration equal to a product of the first change rate and a sum of the first time duration and the second time duration, such that a quotient of the first time duration squared and the period of the driving signal is independent of a change of the first time duration, and the current is independent of the change.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1A illustrates a diagram of a driving circuit, in an embodiment according to the present invention.

FIG. 1B illustrates waveforms of signals received or generated by a converter, in an embodiment according to the present invention.

FIG. 10 illustrates a diagram of a driving circuit, in another embodiment according to the present invention.

FIG. 1D illustrates a diagram of a driving circuit, in another embodiment according to the present invention.

FIG. 2A illustrates a diagram of a controller, in an embodiment according to the present invention.

FIG. 2B illustrates waveforms of signals received or generated by an output circuit, in an embodiment according to the present invention.

FIG. 3 illustrates a ramp generator, in an embodiment according to the present invention.

FIG. 4 illustrates a jitter generator, in an embodiment according to the present invention.

FIG. 5 illustrates waveforms of signals received or generated by a trigger, in an embodiment according to the present invention.

FIG. 6 illustrates a flowchart of examples of operations by a circuit for driving an LED light source, in an embodiment according to the present invention.

FIG. 7A illustrates a block diagram of a driving circuit, in an embodiment according to the present invention.

FIG. 7B illustrates waveforms of signals received or generated by a converter, in an embodiment according to the present invention.

FIG. 8A illustrates a block diagram of a controller, in an embodiment according to the present invention.

FIG. 8B illustrates waveforms of signals received or generated by an output circuit, in an embodiment according to the present invention.

FIG. 9A illustrates a block diagram of a signal generator, in an embodiment according to the present invention.

FIG. 9B illustrates an example of a constant delay generator, in an embodiment according to the present invention.

FIG. 10A illustrates waveforms of signals received or generated by a delay module, in an embodiment according to the present invention.

FIG. 10B illustrates waveforms of signals received or generated by a delay module, in an embodiment according to the present invention.

FIG. 11 illustrates a diagram of a jitter generator, in an embodiment according to the present invention.

FIG. 12 illustrates a diagram of a jitter generator, in an embodiment according to the present invention.

FIG. 13 illustrates a flowchart of examples of operations performed by a circuit for driving an LED light source, in an embodiment according to the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present invention pertain to circuits and methods for powering a light source. In one embodiment, a circuit for powering a LED light source includes a converter and a controller. The converter provides an output voltage to power the light source. The converter includes a first switch which is turned on and off according to a driving signal to control a current through the light source. The controller generates the driving signal, which is a periodic signal having a first state and a second state in a time period. That is, in each time period, the periodic signal experiences a single first state and a single second state, such that the time period is equal in length to the sum of the length of time the periodic signal is in the first state and the length of time the periodic signal is in the second state. The first switch is turned on when the driving signal operates in the first state, and is turned off when the driving signal operates in the second state. The controller modulates time periods of the driving signal and time durations of the first state, such that a quotient of the square of a time duration and a time period is substantially independent of a change to the length of the time period of the driving signal from one time period to another, and such that the current is substantially independent of the change. Advantageously, the switching frequency of the first switch is modulated as the time period changes. The controller further sets the change rates of the time duration and of the time period, such that a quotient of the square of the time duration and the time period is substantially independent of a period change, and the current flowing through the light source is further independent of a period change. Therefore, EMC and stability of the driving circuit are both enhanced.

FIG. 1A illustrates a block diagram of a driving circuit 100, in an embodiment according to the present invention. In the embodiment of FIG. 1A, the driving circuit 100 includes a power supply 122, a rectifier 102, a controller 104, a converter 120, and a LED light source 118. The power supply 122 provides an input voltage V_{IN} (e.g., an alternating sinusoidal voltage). The rectifier 102 rectifies the input voltage V_{IN} to generate a rectified voltage V_{REC}. The converter 120 converts the rectified voltage V_{REc} to an output voltage V_{OUT} to power the LED light source 118. The controller 104 controls the converter 120 to control the current flowing through the LED light source 118.

As shown in FIG. 1A, the controller 104 includes a DRV pin, a CS pin, a COMP pin, and a GND pin. The converter 120 can be but is not limited to a buck converter, which includes a switch 106, a diode 108, a resistor 112, an energy storage unit 114 (e.g. an inductor), and a capacitor 116. The GND pin of the controller is coupled to a reference ground GND1 of the controller 104, and the COMP pin is coupled to the reference ground GND1 via a capacitor 110. In one embodiment, the resistor 112 senses the current flowing through the inductor 114, and generates a sense signal 132 indicating the current flowing through the LED light source 118, accordingly. The controller 104 receives the sense signal 132 via the CS pin and generates a driving signal 130 according to the sense signal 132. The controller 104 provides the driving signal 130 via the DRV pin to the switch 106 in the converter 120. In one embodiment, the switch 106 is turned on and off according to the driving signal 130, such that the current flowing through the inductor 114 is regulated and the current flowing through the LED light source 118 is further regulated.

In one embodiment, the driving signal 130 is a PWM signal with a time period of T_{SW}. The driving signal 130 has a first level (e.g., a high electrical level) and a second level (e.g., a low electrical level) per period. When the driving signal 130 has the first level, the switch 106 is turned on. A current I_{L} then flows through the switch 106, the resistor 112, and the inductor 114, so as to charge the inductor 114. The current I_{L} increases gradually. The growth I_{L,UP} of the current I_{L} can be given by the equation (1):

I_{L,UP}=(V_{REC}−V_{OUT})*T_{ON}/L, (1)

where T_{ON} represents a time duration when the driving signal 130 has the first level, and L represents the inductance of the inductor 114. When the driving signal 130 has the second level, the switch is turned off. The current I_{L} then flows through the diode 108, the resistor 112, and the inductor 114, so as to discharge the inductor 114. The current I_{L} decreases gradually. The reduction I_{L,DOWN} of the current I_{L} can be given by the equation (2):

I_{L,DOWN}−V_{OUT}*T_{DOWN}/L, (2)

where T_{DOWN} represents a time duration for the current I_{L} to drop to zero amperes when the driving signal 130 has the second level. Since the net current of the growth I_{L,UP} and the reduction I_{L,DOWN} is zero (I_{L,UP}+I_{L,DOWN}=0), the relationship between T_{ON} and T_{DOWN} of the current I_{L} can be given by the equation (3):

T_{DOWN}=(V_{REC}−V_{OUT})/V_{OUT}*T_{ON}. (3)

Thus, it can be further given by the equation (4):

T_{ON}+T_{DOWN}=V_{REC}/V_{OUT}*T_{ON}. (4)

The capacitor 116 filters a ripple of the current I_{L} flowing through the inductor 114. Therefore, the current flowing through the LED light source 118 is substantially equal to an average current I_{L,A} of the current I_{L}.

FIG. 1B illustrates waveforms 140 of signals received or generated by a converter (e.g., the converter 120), in an embodiment according to the present invention. FIG. 1B is described in combination with FIG. 1A. In one embodiment, the converter 120 operates in a discontinuous conduction mode. FIG. 1B shows the driving signal 130 and the current I_{L} when the converter operates in a discontinuous conduction mode.

As shown in FIG. 1B, the time period T_{SW} of the driving signal 130 includes a time duration T_{ON} and a time duration T_{OFF}. During the time duration T_{ON}, the driving signal 130 has a high electrical level, and the current I_{L} increases. During the time duration T_{OFF}, the driving signal 130 has a low electrical level. The time duration T_{OFF} further includes a fall time T_{DOWN} and a constant time T_{CONS}. During the fall time T_{DOWN}, the current I_{L} decreases. During the constant time T_{CONS}, the current I_{L} drops to zero amperes, and the current level is maintained at zero, until the driving signal 130 is switched to a high electrical level again (representing entering the next period). Thus, the time period T_{SW} is greater than the sum of time duration T_{ON} and the fall time T_{DOWN}.

According to the waveform of the current I_{L} as shown in FIG. 1B, the average current I_{L,A} flowing through the LED light source 118 can be given by the equation (5):

I_{L,A}=1/2*(I_{L,UP}*T_{ON}+|I_{L,DOWN}|*T_{DOWN})/T_{SW}. (5)

Based on equation (2), (4), and (5), the average current I_{LA} can be further given by the equation (6):

$$\begin{matrix}{I}_{L , A} = 1 / 2 * {I}_{L , UP} * ( {T}_{ON} + {T}_{DOWN} ) / {T}_{SW} \\ = 1 / ( 2 L ) * ( {V}_{REC} - {V}_{OUT} ) * {T}_{ON} * ( {T}_{ON} + {T}_{DOWN} ) / {T}_{SW} \\ = 1 / ( 2 L ) * ( {V}_{REC} - {V}_{OUT} ) * {T}_{ON}^{2} / {T}_{SW} * ( {V}_{REC} / {V}_{OUT} ) .\end{matrix} \qquad ( 6 )$$

Therefore, the average current I_{LA} flowing through the light source 118 is a function of a quotient of the square of the time duration T_{ON} and the time period T_{SW} (T_{ON}²/T_{SW}).

The controller 104 modulates the time period T_{SW} and the time duration T_{ON} of the driving signal 130. In other words, the length of the time period T_{SW} is randomly or regularly changed within a preset range in different periods of the driving signal 130. By way of example, when the driving circuit 100 is powered and activated, the driving signal 130 operates with a first time period of length T_{SW1}, a second time period of length T_{SW2}, a third time period of length T_{SW3}, a fourth time period of length T_{SW4}, and subsequent time periods (e.g., time periods having lengths of T_{SW6}-T_{SW10}). If the maximum change rate of the length of the time period T_{SW1} is set to 10%, the change rates of the lengths of the time periods T_{SW2}, T_{SW3}, T_{SW4}, and subsequent time periods relative to T_{SW1} are less than or equal to 10%. As illustrated in Table 1, T_{SW1}, T_{SW2}, T_{SW3}, T_{SW4}, T_{SW5}, T_{SW6}, T_{SW7}, T_{SW8}, T_{SW9}, and T_{SW10} can be equal to T_{SW,M}, 1.01*T_{SW,M}, 1.02*T_{SW,M}, 1.03*T_{SW,M}, 1.04*T_{SW,M}, 1.05*T_{SW,M}, 1.06*T_{SW,M}, 1.07*T_{SW,M}, 1.08*T_{SW,M}, and 1.09*T_{SW,M}, respectively, where T_{SW,M} represents the length of a predetermined basic time period for the driving signal 130. In one embodiment, the time period T_{SW} of the driving signal 130 is equal to the basic time period T_{SW,M} when the driving circuit 100 is activated. In another embodiment, the time periods T_{SW2}, T_{SW3}, T_{SW4}, and subsequent time periods can be any random value satisfying a maximum change rate of 10%. For example, T_{SW1}, T_{SW2}, T_{SW3}, T_{SW4}, T_{SW5}, T_{SW6}, T_{SW7}, T_{SW8}, T_{SW9}, and T_{SW10} can be equal to T_{SW,M}, 1.03*T_{SW,M}, 1.07*T_{SW,M}, 1.02*T_{SW,M}, 1.05*T_{SW,M}, 1.01*T_{SW,M}, 1.03*T_{SW,M}, 1.02*T_{SW,M}, 1.08*T_{SW,M}, and 1.06*T_{SW,M}, respectively, as illustrated in Table 2.

TABLE 1

| | T_{SW1} | T_{SW2} | T_{SW3} | T_{SW4} | T_{SW5} |
|---|---|---|---|---|---|
| period | T_{SW, M} | 1.01*T_{SW, M} | 1.02*T_{SW, M} | 1.03*T_{SW, M} | 1.04*T_{SW, M} |
| rate | 0 | 1% | 2% | 3% | 4% |
| | T_{SW6} | T_{SW7} | T_{SW8} | T_{SW9} | T_{SW10} |
| period | 1.05*T_{SW, M} | 1.06*T_{SW, M} | 1.07*T_{SW, M} | 1.08*T_{SW, M} | 1.09*T_{SW, M} |
| rate | 5% | 6% | 7% | 8% | 9% |

TABLE 2

| | T_{SW1} | T_{SW2} | T_{SW3} | T_{SW4} | T_{SW5} |
|---|---|---|---|---|---|
| period | T_{SW, M} | 1.03*T_{SW, M} | 1.07*T_{SW, M} | 1.02*T_{SW, M} | 1.05*T_{SW, M} |
| rate | 0 | 3% | 7% | 2% | 5% |
| | T_{SW6} | T_{SW7} | T_{SW8} | T_{SW9} | T_{SW10} |
| period | 1.01*T_{SW, M} | 1.03*T_{SW, M} | 1.02*T_{SW, M} | 1.08*T_{SW, M} | 1.06*T_{SW, M} |
| rate | 1% | 3% | 2% | 8% | 6% |

Advantageously, the switching frequency of the switch 106 is modulated as the time period T_{SW} changes. Since the noise energy of the current I_{L} is distributed around side-band frequencies by switching frequency modulation, the noise energy of the current I_{L} at certain harmonic frequencies is reduced relatively. Therefore, EMC of the driving circuit 100 is improved.

Advantageously, the controller 104 further sets the change rate of the time duration T_{ON} and the change rate of the time period T_{SW}, such that a quotient of the time duration T_{ON} squared and the time period T_{SW} is substantially independent of the period change. According to the equation (6), the average current I_{L,A} through the LED light source 118 is further independent of the period change. Therefore, flickering of the LED light source 118 is avoided and the stability of the driving circuit 100 is enhanced.

The change rate of the time duration T_{ON} and the change rate of the time period T_{OFF} are set as described below.

In one embodiment, the controller 104 controls the time period T_{SW} to have a first change rate a, e.g., T_{SW}=T_{SW,M}*(1+∂), where T_{SW,M} represents a predetermined basic time period for the driving signal 130. The controller 104 further controls the time duration T_{ON} to have a second change rate β, e.g., T_{ON}=T_{ON,M}*(1+β), where T_{ON,M} represents a predetermined basic time duration for the driving signal 130 to be at the first level. In one embodiment, the driving signal 130 has the basic time period T_{SW,M} and the basic time duration T_{ON,M} when the driving circuit 100 is activated. In subsequent periods, the time period T_{SW} and the time duration T_{ON} are modulated relevant to the basic time period T_{SW,M} and the basic time duration T_{ON,M}, respectively. Thus, T_{ON}²/T_{SW} can be given by the equation (7):

$$\begin{matrix}{T}_{ON}^{2} / {T}_{SW} = {[ {T}_{ON , M} ( 1 + β ) ]}^{2} / [ {T}_{SW , M} ( 1 + \partial ) ] \\ = {T}_{ON , M}^{2} / {T}_{SW , M}^{*} ( 1 + 2 β + {β}^{2} ) / ( 1 + \partial ) .\end{matrix} \qquad ( 7 )$$

According to the equation (7), the controller 104 sets the change rate ∂ and β to satisfy 1+∂=(1+β)²=1+2β+β². Then, quotients of the time duration T_{ON} squared and the time period T_{SW} in subsequent periods are equal to a quotient of the basic time duration T_{ON,M} squared and the basic time period T_{SW,M} in the basic period. In other words, when the controller 104 controls the first change rate ∂ of the time period T_{SW} and the second change rate β of the time duration T_{ON} to satisfy the relationship as shown in the equation (8), T_{ON}²/T_{SW} is independent of the period change:

∂=2β+β². (8)

Therefore, as long as the change rate ∂ and β satisfy the equation (8), the current I_{L,A} through the LED light source 118 is substantially independent of the period change. The terminology “substantially” represents that the rectified voltage V_{REC} or the output voltage V_{OUT} may change with the change rate a; however, the change is restricted within a certain range so as not to cause the LED light source 118 to flicker.

In one embodiment, if the maximum value of the second change rate β is set below the predetermined change rate, for example, if β is set less than 5%, then β² in the right side of the equation (8) can be neglected. As such, the equation (8) can be approximately given by the equation (9):

∂=2β. (9)

As shown in the equation (9), in one embodiment, the controller 104 can set the first change rate ∂ of the time period T_{SW} proportional to the second change rate β of the time duration T_{ON}. More specifically, the controller 104 can set the first change rate a to be two (2) times the second change rate β. When the maximum value of the change rate β is set below the predetermined change rate (e.g., less than 5%), a quotient of the time duration T_{ON} squared and the time period T_{SW} is substantially independent of the period change by this method of setting. However, as understood by a person skilled in the art, the controller 104 can set the ratio between ∂ and β to other values close to 2, for example, ∂=1.98*β, or ∂=2.02*β, as long as the setting of ∂ and β prevents the LED light source 118 from flickering.

FIG. 10 illustrates a block diagram of a driving circuit 150, in an embodiment according to the present invention. Elements labeled the same as in FIG. 1A have similar functions. FIG. 10 is described in combination with FIG. 1A. In the embodiment of FIG. 10, a converter 160 is a boost converter. However, the converter 160 can have other configurations and is not limited to the example in FIG. 1A and FIG. 1C.

The driving circuit 150 includes the power supply 122, the rectifier 102, the controller 104, the converter 160, and the LED light source 118. In the embodiment of FIG. 10, the converter 160 includes a switch 166, a diode 168, a resistor 172, an energy storage unit 174 (e.g. an inductor), and a capacitor 176.

When the driving signal 130 has the first level (e.g., a high electrical level), the switch 166 is turned on. A current I_{L}′ flows through the inductor 174, the switch 166, and the resistor 172, to charge the inductor 174. The current I_{L}′ increases gradually. When the driving signal 130 has the second level (e.g., a low electrical level), the switch 166 is turned off. The inductor 174 is discharged and the current I_{L}′ then flows from the inductor 174 through the diode 168 to the LED light source 118. The current I_{L}′ decreases gradually. Similar to the description in FIG. 1A, the average current I_{LA}′ flowing through the LED light source 118 can be given by the equation (10):

$$\begin{matrix}{I}_{L , A}^{′} = 1 / 2 * {I}_{L , UP}^{′} * {T}_{DOWN}^{′} / {T}_{SW}^{′} \\ = 1 / ( 2 {L}^{′} ) * {V}_{REC} * {T}_{ON}^{′} * {T}_{DOWN}^{′} / {T}_{SW}^{′} \\ = 1 / {( 2 {L}^{′} )}^{*} {T}_{ON}^{′2} / {T}_{SW}^{′} * {V}_{REC}^{2} / ( {V}_{OUT} - {V}_{REC} ) .\end{matrix} \qquad ( 10 )$$

Thus, the average current I_{L,A}′ flowing through the light source 118 is also a function of a quotient of the time duration T_{ON}′ squared and the time period T_{SW}′ (T_{ON}′²/T_{SW}′). Advantageously, the controller 104 modulates the time period T_{SW}′ and the time duration T_{ON}′ of the driving signal 130 in a similar way, such that EMC of the driving circuit 150 is improved. The controller 104 further sets the change rates of the time duration T_{ON}′ and the time period T_{SW}′, such that a quotient of the time duration T_{ON}′ squared and the time period T_{SW}′ is substantially independent of the period change. Thus, the average current I_{L,A}′ flowing through the LED light source 118 is independent of the period change. Therefore, the stability of the driving circuit 150 is enhanced.

FIG. 1D illustrates a block diagram of a driving circuit 180, in an embodiment according to the present invention. Elements labeled the same as in FIG. 1A have similar functions. In the embodiment of FIG. 1D, a converter 182 is a low-side buck converter including a diode 184, a switch 186, and a resistor 188 coupled in series, an energy storage unit 114 (e.g., an inductor), and a capacitor 116. However, the converter 182 can have other configurations and is not limited to the examples in FIG. 1A, FIG. 10, and FIG. 1D. The driving circuit 180 in FIG. 1D operates similarly to the driving circuit 100 in FIG. 1A.

FIG. 2A illustrates a block diagram of the controller 104, in an embodiment according to the present invention. Elements labeled the same as in FIG. 1A have similar functions. FIG. 2A is described in combination with FIG. 1A and FIG. 1B.

In one embodiment, the controller 104 includes a ramp generator 202, a sensing circuit 212, and an output circuit 214. The sensing circuit 212 receives the sense signal 132 via the CS pin. The sense signal 132 indicates the current flowing through the LED light source 118. The sensing circuit 212 generates the reference signal 134 on the COMP pin according to the sense signal 132. The ramp generator 202 generates a ramp signal RAMP. In one embodiment, the ramp signal RAMP is a periodic signal, which rises from a valley value V_{N} to a peak value V_{P} and then falls from the peak value V_{P} to the valley value V_{N} per period. The ramp generator 202 further generates a control signal CTR. In one embodiment, the control signal CTR is a PWM signal, which has a third level (e.g., a high electrical level) when the ramp signal RAMP rises, and has a fourth level (e.g., a low electrical level) when the ramp signal RAMP falls. The output circuit 214 receives the reference signal 134 and the ramp signal RAMP, and accordingly generates the driving signal 130 on the DRV pin of the controller 104, so as to operate the switch 106 on and off alternately. In one embodiment, the ramp generator 202 regulates the rising rate and the falling rate of the ramp signal RAMP, so as to modulate the time period T_{SW} and the time duration T_{ON} of the driving signal 130. For example, the time period T_{SW} of the driving signal 130 has a first change rate ∂, while the time duration T_{ON} has a second change rate β. When the change rates ∂ and β satisfy either the equation (8) or (9), the current I_{L,A} through the LED light source 118 is substantially independent of the period change. The operation of the ramp generator 202 is further described in FIG. 3.

In one embodiment, the sensing circuit 212 includes a filter 204 and an error amplifier 206. The filter 204 receives the sense signal 132 indicating a transient current I_{L} flowing through the inductor 114, and filters the sense signal 132 to generate a filter signal 216. In one embodiment, the filter signal 216 indicates an average current I_{L,A} flowing through the LED light source 118. The error amplifier 206 receives the filter signal 216 at the inverting input terminal, receives the reference signal REF indicating a desired current level for the average current I_{L,A} at the non-inverting input terminal, and generates the reference signal 134 at the output terminal. In one embodiment, the reference signal 134 is determined by a difference between the reference signal REF and the filter signal 216.

The output circuit 214 includes a comparator 208 and a trigger 210. The comparator 208 compares the ramp signal RAMP with the reference signal 134. The trigger 210 generates the driving signal 130 according to the control signal CTR and a result of the comparison, so as to turn the switch 106 on and off alternately.

FIG. 2B illustrates waveforms 220 of signals received or generated by the output circuit 214, in an embodiment according to the present invention. FIG. 2B is described in combination with FIG. 2A. FIG. 2B shows the control signal CTR, the ramp signal RAMP, and the driving signal 130.

In one embodiment, the output circuit 214 receives the reference signal 134, the ramp signal RAMP, and the control signal CTR. As shown in FIG. 2B, the control signal CTR is a PWM signal. During a rise time T_{UP} from T₀ to T₂, the ramp signal RAMP ramps up, and the control signal CTR has a high level. During a fall time T_{DW} from T₂ to T₃, the ramp signal RAMP ramps down, and the control signal CTR has a low level. More specifically, the ramp signal RAMP is equal to the valley value V_{N} at time T₀, and the control signal CTR is then switched to a high level. From T₀ to T₁, the ramp signal RAMP rises from the valley value V_{N} to an intermediate level which is equal to the reference signal 134. Since the ramp signal RAMP is less than the reference signal 134 and the control signal CTR has a high level, the driving signal 130 has the first level (e.g., a high level). From T₁ to T₂, the ramp signal RAMP rises from the intermediate level to the peak value V_{P}. Since the ramp signal RAMP is greater than the reference signal 134 and the control signal CTR has a high level, the driving signal 130 has the second level (e.g., a low level). At time T₂, the control signal CTR is switched to a low level when the ramp signal RAMP reaches the peak value V_{P}. From T₂ to T₃, the ramp signal RAMP falls from the peak value V_{P} to the valley value V_{N}. Since the control signal CTR has a low level, the driving signal 130 maintains the second level (e.g., a low level). At time T₃, the controller 104 enters next period.

As shown in FIG. 2B, the time duration T_{ON} of the driving signal 130 is equal to a time duration for the ramp signal RAMP to rise from the valley value V_{N} to a level equal to the reference signal 134. Thus, a change rate of the rising rate of the ramp signal RAMP determines a change rate of the time duration T_{ON}. In one embodiment, by setting the change rate of the rise time T_{UP} indicating the rising rate to β, the time duration T_{ON} has a change rate of β. Furthermore, the time period T_{SW} of the driving signal 130 is equal to a sum of the rise time T_{UP} for the ramp signal RAMP to rise from the valley value V_{N} to the peak value V_{P} and the fall time T_{DW} for the ramp signal RAMP to fall from the peak value V_{P} to the valley value V_{N}. Thus, the change rate of the rising rate determines a change rate of the rise time T_{UP}, and a change rate of the falling rate determines a change rate of the fall time T_{DW}. In other words, both the change rates of the rising rate and of the falling rate determine a change rate of the time period T_{SW}. In one embodiment, the ramp signal RAMP has a time period equal to the time period T_{SW} of the driving signal 130. By setting the change rate of time period of the ramp signal RAMP indicating the rising rate and the falling rate to 2β, the time period T_{SW} has a change rate of 2β. Advantageously, the ramp generator 202 modulates the time period T_{SW} and the rise time T_{UP} of the ramp signal RAMP with a change rate of 2β and β, respectively, such that the time period T_{SW} and the time duration T_{ON} of the driving signal 130 have a change rate of 2β and β, respectively. Therefore, the output current is substantially independent of the period change.

FIG. 3 illustrates a block diagram of the ramp generator 202, in an embodiment according to the present invention. FIG. 3 is described in combination with FIG. 2A and FIG. 2B.

In one embodiment, the ramp generator 202 includes a current generator 306, a switch 310, a switch 312, an energy storage unit 322 (e.g., a capacitor), and a control circuit 318. In one embodiment, the current generator 306 generates a charging current I_{CH} and a discharging current I_{DISCH}. The switch 310 selectively conducts a current path for the charging current I_{CH} according to the control signal CTR to charge the capacitor 322. The switch 312 selectively conducts a current path for the discharging current I_{DISCH} according to the control signal CTR to discharge the capacitor 322. The capacitor 322 operates to provide the ramp signal RAMP. The control circuit 318 generates the control signal CTR according to the ramp signal RAMP, so as to control the conduction status of the switch 310 and 312.

More specifically, when the control signal CTR has a high level, the switch 312 is turned off and the switch 310 is turned on. As such, the charging current I_{CH} flows to the capacitor 322 to charge the capacitor 322. The ramp signal RAMP then gradually rises from the valley value V_{N} to the peak value V_{P}, with a rising rate determined by the charging current I_{CH}. When the control signal CTR has a low level, the switch 310 is turned off and the switch 312 is turned on. As such, the discharging current I_{DISCH} flows from the capacitor 322 to discharge the capacitor 322. The ramp signal RAMP then gradually falls from the peak value V_{P} to the valley value V_{N}, with a falling rate determined by the discharging current I_{DISCH}.

In one embodiment, the control circuit 318 includes a comparator 314 and a trigger 316. The comparator 314 compares the ramp signal RAMP and the peak value V_{P}, and compares the ramp signal RAMP and the valley value V_{N}. Based upon the results of two comparisons, the comparator 314 generates the trigger signal TRG. The trigger 316 generates the control signal CTR according to the trigger signal TRG. Combined with the description in FIG. 2B, when the ramp signal RAMP rises to the peak value V_{P} (e.g., at time T₂), the trigger signal TRG has a fifth level (e.g., a low level) to reset the trigger 316, such that the control signal CTR is switched to a low level. Then, the capacitor 322 is discharged and accordingly the ramp signal RAMP drops down. When the ramp signal RAMP drops to the valley value V_{N} (e.g., at time T₃), the trigger signal TRG has a sixth level (e.g., a high level) to set the trigger 316, such that the control signal CTR is switched to a high level. Then, the capacitor 322 is charged and accordingly the ramp signal RAMP rises.

In one embodiment, the current generator 306 regulates the charging current I_{CH} and the discharging current I_{DISCH} to modulate the time period T_{SW} and the time duration T_{ON} with a change rate according to the equation (8) or (9) in different periods. In the embodiment of FIG. 3, the current generator 306 includes a constant current generator 302 and a jitter current generator 304. The constant current generator 302 generates a first current I₁ and a second current I₂. The jitter current generator 304 generates a first jitter current I_{J1} and a second jitter current I_{J2}. The ramp generator 202 (FIG. 2A) merges the first current I₁ and the first jitter current I_{J1} to generate the charging current I_{CH}, and merges the second current I₂ and the second jitter current I_{J2} to generate the discharging current I_{DISCH}. In one embodiment, the first current I₁ and the second current I₂ remain constant. However, the first jitter current I_{J1} and the second jitter current I_{J2} have different current levels in different periods of the driving signal 130, such that the charging current I_{CH} and the discharging current I_{DISCH} have different current levels in different periods. Accordingly, the rising rate and the falling rate of the ramp signal RAMP change. The operation of the jitter current generator 304 is further described in FIG. 4.

In one embodiment, according to the equation (9), in order to set the change rate of the time duration T_{ON} and of the time period T_{SW} to be β and 2β, respectively, the constant current generator 302 maintains a ratio between the second current I₂ and the first current at a first predetermined level k, e.g., I₂=k*I₁. Moreover, the jitter current generator 304 maintains a ratio between the second jitter current I_{J2} and the first jitter current I_{J1} at a second predetermined level a*k, e.g., I_{J2}=a*k*I_{J1}. In other words, when the ramp signal RAMP drops to the valley value V_{N}, the first current and the second current I₂ remain constant, and a ratio between the second current I₂ and the first current is the first predetermined level. Furthermore, the first jitter current I_{J1} and the second jitter current Iⱼ₂ change, but a ratio between the second jitter current I_{J2} and the first jitter current I_{J1} remains constant. For example, the first jitter current I_{J1} is regulated from I_{J1}_{_{—}}₁ to I_{J1}_{_{—}}₂, and the second jitter current I_{J2} is regulated from I_{J2}_{_{—}}₁ to I_{J2}_{_{—}}₂, where a ratio between I_{J2}_{_{—}}₁ and I_{J1}_{_{—}}₁ is equal to a ratio between I_{J2}_{_{—}}₂ and I_{J1}_{_{—}}₂, and further equal to the second predetermined level.

The predetermined levels a and k are set as further described below. Specifically, in the following examples, the setting of the predetermined levels is conducted under the condition that the first jitter current I_{J1} and the second jitter current I_{J2} are modulated within a relatively small range (e.g., the change rate β is less than 5%). Thus, based upon linear approximation principle of Taylor Series, the expression 1/(1+β) with a variable of β can be represented by 1−β with a linear approximation. Similarly, the expression 1+2β can be represented by 1/(1−2β).

In one embodiment, the charging current I_{CH} determines the rising rate of the ramp signal RAMP. More specifically, the charging current I_{CH} is inversely proportional to the rise time T_{UP} of the ramp signal RAMP. When the change rate of the rise time T_{UP} is set to β (such that the time duration T_{ON} is set to have a change rate (3), the charging current I_{CH} can be represented by I_{CH}=I_{CH,M}/(1+β). According to the linear approximation principle, the charging current I_{CH} can be further represented by I_{CH}=I_{CH,M}*(1−β). In other words, the charging current I_{CH} has an approximate change rate of −β. Thus, if β is set to a relatively small value, the rise time T_{UP} has a change rate of β by setting the charging current I_{CH} with a change rate of −β, such that the change rate of the time duration T_{ON} is equal to β. By way of example, if the charging current I_{CH} drops 0.5% relative to the last period in one period, it can be approximated that the time duration T_{ON} grows 0.5% relative to the last period.

More specifically, the charging current I_{cH} equals a sum of the first current I₁ and the first jitter current I_{J1}, where the first current I₁ has a constant current value and the first jitter current I_{J1} determines the change rate of the charging current I_{CH}. In one embodiment, by setting the first jitter current I_{J1} equal to the first current I₁ multiplied by the change rate −β, e.g., I_{J1}=(−β)*I_{J1}=(−β)*I₁, the charging current I_{CH} has a change rate of −β. Specifically, when the change rate β has a positive value, it indicates that the directions of the first jitter current I_{J1} and the first current I₁ are opposite, that is, the charging current I_{CH} is less than the first current I₁. When the change rate β has a negative value, it indicates that the directions of the first jitter current I_{J1} and the first current I₁ are the same, that is, the charging current I_{CH} is greater than the first current I₁. Therefore, the charging current I_{CH} can be given by the equation (11):

I_{CH}=I₁+I_{J1}=I₁*(1−β). (11)

Similarly, the discharging current I_{DISCH} can be given by the equation (12):

I_{DISCH}=I₂+I_{J2}=k*I₁*(1−a*β). (12)

It is described as followings how to set the predetermined levels a and k to make the time period T_{SW} have a change rate of 2β.

As described in FIG. 2B, both the rise time T_{UP} and the fall time T_{DW} of the ramp signal RAMP determine the time period T_{SW} of the ramp signal RAMP. The time period T_{SW} can be given by the equation (13):

T_{SW}=T_{UP}+T_{DW}=(V_{P}−V_{N})*(C/I_{CH}+C/I_{DISCH}), (13)

where C represents the capacitance of the capacitor 322. By substituting the equation (11) and (12) into (13), then the time period T_{SW} can be further given by the equation (14):

$${T}_{SW} = ( {V}_{P} - {V}_{N} ) C ( \frac{1 - \frac{ak + 1}{1 + k} β}{\frac{{kI}_{1}}{1 + k} [ 1 - ( 1 + a ) β + a {β}^{2} ]} ) . \qquad ( 14 )$$

If the basic time period of the driving signal 130 is preset when the jitter currents I_{J1} and I_{J2} are equal to zero, the basic time period T_{SW,M} can be represented by

$${T}_{SW , M} = ( {V}_{P} - {V}_{N} ) C ( \frac{1 + k}{{kI}_{1}} ) ,$$

such that the subsequent time periods can be expressed by

$${T}_{SW} = {T}_{SW , M} * ( \frac{1 - \frac{ak + 1}{1 + k} β}{1 - ( 1 + a ) β + a {β}^{2}} ) .$$

Since the time period T_{SW} has a change rate of 2β relative to T_{SW,M}, the time period T_{SW} can be represented by T_{SW}=T_{SW,M}*(1+2β). According to the linear approximation principle, the time period T_{SW} can be further expressed by T_{SW}=T_{SW,M}/(1−2β). As such, it can be given in the equation (15):

$$\frac{1}{1 - 2 β} = \frac{1 - \frac{ak + 1}{1 + k} β}{\frac{{kI}_{1}}{1 + k} [ 1 - ( 1 + a ) β + a {β}^{2} ]} , \qquad ( 15 )$$

After simplification, it can be given in the equation (16):

$$1 - ( \frac{ak + 1}{1 + k} + 2 ) β + 2 * \frac{ak + 1}{1 + k} {β}^{2} = 1 - ( 1 + a ) β + a {β}^{2} , \qquad ( 16 )$$

When the change rate β is modulated within a relatively small range (e.g., β is less than 5%), β² in the right side of the equation (16) can be neglected. The coefficient of β in the left side of the equation is equal to that in the right side, that is,

$$\frac{ak + 1}{1 + k} + 2 = 1 + a .$$

Thus, a=k+2. For example, in one embodiment, a is set to 6 while k is set to 4. In other words, when the constant current generator 302 maintains the ratio between the second current I₂ and the first current I₁ at 4, and the jitter current generator 304 maintains the ratio between the second jitter current I_{J2} and the first jitter current I_{J1} at 24, the change rate of the time period T_{SW} of the driving signal 130 is substantially two times of that of the time duration T_{ON}; that is, the equation (9) is satisfied. However, as understood by a person skilled in the art, a and k can be set to other values according to the equation (16).

Therefore, in the embodiment of FIG. 3, when the current generator 306 sets the charging current I_{CH} to have a change rate of −β, the change rate of the time duration T_{ON} can be approximately set to β. In the meanwhile, in subsequent periods, the current generator 306 maintains the ratio between the second current I₂ and the first current at the first determined level k, and also maintains the ratio between the second jitter current I_{J2} and the first jitter current I_{J1} at the second determined level a*k, where a and k are set in relation to the equation (16). Thus, in any subsequent period, the time period T_{SW} has an approximate change rate of 2β. As described in FIG. 2A (as shown in the equation (9)), the output current flowing through the LED light source 118 is substantially independent of the period change, accordingly.

FIG. 4 illustrates a diagram of the jitter current generator 304, in an embodiment according to the present invention. FIG. 4 is described in combination with FIG. 3. In the embodiment of FIG. 4, the change rate β makes regular changes in different periods of the driving signal 130.

In one embodiment, the jitter current generator 304 includes a jitter generating module 402, a trigger 404, a current source 406 and a current mirror 408. In one embodiment, the trigger 404 includes multiple D-triggers coupled in series. The trigger 404 receives the control signal CTR, and generates the jitter signals J1, J2 and J3 accordingly. How the trigger 404 generates the jitter signals J1, J2 and J3 according to the control signal CTR is further described in FIG. 5. The current source 406 generates a reference current I_{REF} indicating the first current I₁. The jitter generating module 402 receives the reference current I_{REF}, and generates the first jitter current I_{J1} according to the jitter signals J1, J2 and J3. The current mirror 408 receives the first jitter current I_{J1}, and accordingly generates the second jitter current I_{J2}. The current mirror 408 maintains a ratio between I_{J2} and I_{J1} at the second predetermined level a*k.

In one embodiment, the jitter generating module 402 includes transistors M0 to M3 coupled in parallel, and switches S1 to S3 coupled in series to the transistors M1 to M3. The transistors M1 to M3 constitute multiple current mirrors with M0, respectively, for generating the current I_{PRE1}, I_{PRE2}, and I_{PRE3}. The conductance status of the switches S1 to S3 is controlled by the jitter signals J1 to J3, such that the first jitter current I_{J1} is generated accordingly. Take the switch S1 for example, if J1 has a high level (represented by logic 1), the switch S1 is turned on; if J1 has a low level (represented by logic 0), the switch S1 is turned off. The switches S2 and S3 operate similarly as S1.

FIG. 5 illustrates waveforms 500 of signals received or generated by the trigger 404, in an embodiment according to the present invention. FIG. 5 is described in combination with FIG. 4. FIG. 5 shows the control signal CTR, and the jitter signals J1,J2, and J3. FIG. 5 describes how the trigger 404 generates the jitter signals J1, J2, and J3 according to the control signal CTR.

In the embodiment of FIG. 5, the jitter signals J1, J2, and J3 are represented by logic signals. For example, logic 1 corresponds to a high level of the corresponding signal, while logic 0 corresponds to a low level of the corresponding signal. In one embodiment, the jitter signals J1, J2, and J3 are switched according to the control signal CTR. Specifically, in one embodiment, the jitter signals J1, J2, and J3 are triggered by the rising edges of the control signal CTR. With the jitter signals J1,J2, and J3 represented as a binary number J1J2J3, as shown in FIG. 5, every rising edge of the control signal CTR triggers the addition of 1 to the binary number. More specifically, J1J2J3 increases progressively from 000 to 001, 010, 011, 100, 101, 110, and 111 in subsequent periods, and so on.

In one embodiment, the relationship between the first jitter current I_{J1} and the jitter signals J1, J2, and J3 is illustrated in Table 3.

TABLE 3

| J1J2J3 | I_{J1} |
|---|---|
| 000 | 0 |
| 001 | I_{PRE3} |
| 010 | I_{PRE2} |
| 011 | I_{PRE3} + I_{PRE2} |
| 100 | I_{PRE1} |
| 101 | I_{PRE3} + I_{PRE1} |
| 110 | I_{PRE2} + I_{PRE1} |
| 111 | I_{PRE3} + I_{PRE2} +I_{PRE1} |

As described in FIG. 4, for the transistor M1, when the jitter signal J1 is logic 1, the switch S1 is turned on to conduct the current I_{PRE1}; when the jitter signal J1 is logic 0, the switch S1 is turned off to cut off the current I_{PRE1}. Other switches operate similarly. Thus, according to FIG. 5, the binary value J1J2J3 has eight (8) different states in 8 adjacent periods. As such, the switches S1, S2, and S3 have 8 conductance statuses. Accordingly, the first jitter current I_{J1} has 8 different current levels in these 8 adjacent periods. More specifically, when J1J2J3 has a value of 000, 001, 010, 011, 100, 101, 110, and 111, the first jitter current I_{J1} is equal to 0, I_{PRE3}, I_{PRE2}, I_{PRE2}+I_{PRE3}, I_{PRE1}, I_{PRE1}+I_{PRE3}, I_{PRE1}+I_{PRE2}, and I_{PRE1}+I_{PRE2}+I_{PRE3}, respectively. In one embodiment, the setting of the currents I_{PRE1}, I_{PRE2}, and I_{PRE3} satisfies I_{PRE1}>I_{PRE2}+I_{PRE3}>I_{PRE2}>I_{PRE3}, e.g., I_{PRE1}=4 uA, I_{PRE2}=2 UA, and I_{PRE3}=1 uA. Thus, the first jitter current I_{J1} increases in these 8 periods.

However, the present invention is not limited to the embodiments shown in FIG. 4 to FIG. 5. In another embodiment, the trigger 404 is triggered to decrease progressively. In other words, J1J2J3 can be equal to 111, 110, 101, 100, 011, 010, 001, and 000 in 8 adjacent periods. Thus, the first jitter current I_{J1} gradually decreases. In yet another embodiment, the trigger 404 can be replaced by a random generator. When a rising edge of the control signal CTR is detected, the random generator generates the jitter signals J1, J2, and J3 randomly. In this situation, the first jitter current Iⱼ₁ can either increase or decrease progressively in different periods.

FIG. 6 illustrates a flowchart 600 of examples of operations performed by a circuit for driving an LED light source, e.g., the circuit 100,150, or 180. FIG. 6 is described in combination with FIG. 1A to FIG. 5B. Although specific steps are disclosed in FIG. 6, such steps are examples. That is, the present invention is well suited to performing various other steps or variations of the steps recited in FIG. 6.

In block 602, an input voltage (e.g., the rectified voltage V_{REC}) is converted to an output voltage (e.g., the output voltage V_{OUT}) based on a conductance status of a first switch (e.g., the switch 106) to power the light source (e.g., the LED light source 118).

In block 604, a driving signal (e.g., the driving signal 130) is generated to operate the first switch on and off alternately to control a current through the light source. In one embodiment, the driving signal is a periodic signal having a first state (e.g., a high level) and a second state (e.g., a low level) in a period. The first switch is turned on when the driving signal operates in the first state, and is turned off when the driving signal operates in the second state. In one embodiment, a reference signal (e.g., the reference signal 134) is received. A ramp signal (e.g., the ramp signal RAMP) is generated, which ramps up and down periodically. The driving signal is generated according to the reference signal and the ramp signal. Specifically, the period of the driving signal includes a first time duration and a second time duration. The ramp signal rises from a valley value (e.g., the valley value V_{N}) to an intermediate value equal to the reference signal during the first time duration, and rises from the intermediate value to a peak value (e.g., the peak value V_{P}) and then falls from the peak value to the valley value during the second time duration. The driving signal operates in the first state during the first time duration and operates in the second state during the second time duration.

In one embodiment, the ramp signal is compared with a first threshold (e.g., the voltage V_{P}), and is compared with a second threshold (e.g., the voltage V_{N}). A discharging current (e.g., the current I_{DISCH}) is conducted to discharge a capacitor (e.g., the capacitor 322) when the ramp signal rises to the first threshold, then the ramp signal ramps down. A charging current (e.g., the current I_{CH}) is conducted to charge the capacitor when the ramp signal falls to the second threshold, then the ramp signal ramps up. In one embodiment, a first current (e.g., the current I₁) and a first jitter current (e.g., the current I_{J1}) are merged to generate the charging current. A second current (e.g., the current I₂) and a second jitter current (e.g., the current I_{J2}) are merged to generate the discharging current. The second current is proportional to the first current, and the second jitter current is proportional to the first jitter current.

In block 606, a time period (e.g., the time period T_{SW}) of the driving signal and a time duration (e.g., the time duration T_{ON}) of the first state are modulated, such that a quotient of the time duration squared and the time period is substantially independent of a change of the time period in each period of the driving signal, and the current is substantially independent of the change. In one embodiment, a change rate ∂ of the time period and a change rate β of the time duration satisfy 1+∂=(1+β)². In another embodiment, a change rate of the time period is proportional to a change rate of the time duration. Specifically, the change rate of the time period is two times the change rate of the time duration.

In one embodiment, a rising rate and a falling rate of the ramp signal are regulated to control the time period and the time duration. In one embodiment, the first current and the second current are maintained constant, where a ratio between the second current and the first current is equal to a first predetermined level. The first jitter current and the second jitter current are regulated when the ramp signal drops to the second threshold, where a ratio between the second jitter current and the first jitter current is maintained equal to a second predetermined level, such that the quotient between the time duration squared and the time period is substantially independent of the period change.

FIG. 7A illustrates a block diagram of a driving circuit 700, in an embodiment according to the present invention. Elements labeled the same as in FIG. 1A have similar functions. FIG. 7A is described in combination with FIG. 1A.

In the embodiment of FIG. 7A, the driving circuit 700 includes a power supply 122, a rectifier 102, a controller 704, a converter 720, and a LED light source 118. The rectifier 102 receives an input voltage V_{IN} (e.g., an alternating sinusoidal voltage) provided by the power supply 122, and rectifies the input voltage V_{IN} to generate a rectified voltage V_{REC}. The converter 720 converts the rectified voltage V_{REC} to an output voltage V_{OUT} to power the LED light source 118. The controller 704 controls the converter 720 to control a current flowing through the LED light source 118.

As shown in FIG. 7A, the controller 704 includes a DRV pin, a CS pin, a COMP pin, a GND pin, and a ZCD pin. The converter 720 can be but is not limited to a buck converter, which includes a switch 706, a diode 708, a resistor 712, an energy storage unit 714 (e.g. an inductor), and a capacitor 716. The converter 720 further includes a detection circuit 736. The GND pin of the controller 704 is coupled to a reference ground GND3 of the controller 704, and the COMP pin is coupled to the reference ground GND3 via a capacitor 710. In one embodiment, the reference ground GND3 of the controller 704 is different from a reference ground GND4 of the driving circuit 700.

In one embodiment, the detection circuit 736 includes a transformer having a primary winding 724 and a secondary winding 722. The primary winding 724 is coupled to the inductor 714 in parallel, and the secondary winding 722 is coupled to the reference ground GND3 of the controller 704 via a diode 726 and a capacitor 728. In one embodiment, the secondary winding 722 provides a detection signal 730 indicating whether the current flowing through the LED light source 118 has dropped to a specified level, e.g., zero amperes. A sensor, e.g., the resistor 712, senses a current flowing through the inductor 714, and accordingly generates a sense signal 732 indicating the current flowing through the LED light source 118. The controller 704 receives the detection signal 730 and the sense signal 732 via the ZCD pin and the CS pin, respectively, and generates a driving signal PWM according to the detection signal 730 and the sense signal 732. The controller 704 provides the driving signal PWM via the DRV pin to the switch 706 in the converter 720. In one embodiment, the switch 706 is turned on and off according to the driving signal PWM, such that the current flowing through the inductor 714 is regulated and the current flowing through the LED light source 118 is further regulated.

FIG. 7B illustrates waveforms 740 of signals received or generated by a converter (e.g., the converter 720), in an embodiment according to the present invention. FIG. 7B is described in combination with FIG. 7A. In one embodiment, the converter 720 operates in a discontinuous conduction mode. It should be understood that such description is for illustrative purpose only and does not limit the scope of the present teaching. It is understood that the converter 720 can also operate in a quasi-resonant mode. FIG. 7B shows the driving signal PWM, the current I_{L} flowing through the inductor 714, the detection signal 730, and a detection signal ZCDO when the converter 720 operates in a discontinuous conduction mode.

In one embodiment, the driving signal PWM is a pulse-width modulation (PWM) signal with a period T_{SW}. As shown in FIG. 7B, the period T_{SW} of the driving signal PWM includes a time duration T_{ON} and a time duration T_{OFF}. During the time duration T_{ON}, the driving signal PWM has a high electrical level and the current I_{L} increases. During the time duration T_{OFF}, the driving signal PWM has a low electrical level. The time duration T_{OFF} further includes a fall time period T_{DOWN} and a constant time period T_{CONS}. During the fall time period T_{DOWN}, the current I_{L} decreases. During the constant time period T_{CONS}, the current I_{L} drops to zero amperes, and the current level is maintained at zero, until the driving signal PWM is switched to a high electrical level (representing entering the next period). Similar to the equation (6) described in the discussion of FIG. 1A, an average current I_{L,A} through the LED light source 118 can be given by the equation (17):

I_{L,A}=1/(2L)*(V_{REC}−V_{OUT})*T_{ON}²/T_{SW}*(V_{REC}/V_{OUT}). (17)

Therefore, the average current I_{L,A} flowing through the light source 118 is a function of a quotient of the square of the time duration T_{ON} and the period T_{SW} (T_{ON}²/T_{SW}).

Furthermore, during the fall time period T_{DOWN}, the current I_{L} decreases. As such, a voltage across the secondary winding 722 is positive. In one embodiment, the detection signal 730 is equal to the voltage across the secondary winding 722. Thus, as shown in FIG. 7B, the detection signal 730 has a positive voltage V₃. During the constant time period T_{CONS}, the current I_{L} remains zero and the voltage across the secondary winding 722 is zero volts. Thus, the detection signal 730 has a voltage V₄ (e.g., zero volts). During the time duration T_{ON}, the current I_{L} increases and the voltage across the secondary winding 722 is negative. Thus, the detection signal 730 has a negative voltage V₅.

In one embodiment, the controller 704 generates a detection signal ZCDO according to the detection signal 730. More specifically, the detection signal ZCDO has a low level when the detection signal 730 has a voltage of V₃, and has a high level when the detection signal 730 has a voltage of V₄ or V₅. Therefore, when the detection signal ZCDO is low, then it indicates the fall time period T_{DOWN} of the current I_{L} through the inductor 714.

FIG. 8A illustrates a block diagram of a controller (e.g., the controller 704), in an embodiment according to the present invention. FIG. 8A is described in combination with FIG. 7A and FIG. 7B.

In one embodiment, the controller 704 includes a signal generator 802, a sensing circuit 812, and an output circuit 814. The sensing circuit 812 receives the sense signal 732 via the CS pin and receives the detection signal 730 via the ZCD pin. In one embodiment, the sensing circuit 812 generates the detection signal ZCDO according to the detection signal 730. The sensing circuit 812 further generates a reference signal 734 and a current signal I_{COMP} according to the sense signal 732. The signal generator 802 generates a ramp signal RAMP. In one embodiment, the ramp signal RAMP is a periodic signal, which rises from a valley value V_{N} to a peak value V_{P} and then falls from the peak value V_{P} to the valley value V_{N} per period. Furthermore, the signal generator 802 receives the detection signal ZCDO and the current signal I_{COMP}, and accordingly generates a control signal ON. In one embodiment, the control signal ON is a pulse signal. The output circuit 814 receives the reference signal 734, the ramp signal RAMP, and the control signal ON, and generates the driving signal PWM on the DRV pin of the controller 704, accordingly, so as to operate the switch 706 on and off alternately. In one embodiment, the signal generator 802 regulates a rising rate of the ramp signal RAMP to modulate the time duration T_{ON}, and controls the control signal ON to modulate the period T_{SW}.

In one embodiment, the sensing circuit 812 includes a filter 804, an error amplifier 806, a current detector 818, and a voltage-current converter 816. In one embodiment, the current detector 818 receives the detection signal 730, and generates the detection signal ZCDO, accordingly. The filter 804 receives the sense signal 732 indicating a transient current I_{L} flowing through the inductor 714, and filters the sense signal 732 to generate a filter signal 820. In one embodiment, the filter signal 820 indicates an average current I_{L,A} flowing through the LED light source 118. The error amplifier 806 receives the filter signal 820 at the inverting input terminal, receives the reference signal REF indicating a desired current level for the average current I_{L,A} at the non-inverting input terminal, and generates the reference signal 734 at the output terminal. In one embodiment, the reference signal 734 is determined by a difference between the reference signal REF and the filter signal 820. In one embodiment, the voltage-current converter 816 then converts the reference signal 734 to the current signal I_{COMP} which is proportional to the reference signal 734.

The output circuit 814 includes a comparator 808 and a trigger 810. The comparator 808 compares the ramp signal RAMP with the reference signal 734. The trigger 810 generates the driving signal PWM according to the control signal ON and a result of this comparison, so as to turn the switch 706 on and off alternately.

FIG. 8B illustrates waveforms 850 of signals received or generated by an output circuit (e.g., the output circuit 814), in an embodiment according to the present invention. FIG. 8B is described in combination with FIG. 8A. FIG. 8B shows the control signal ON, the ramp signal RAMP, and the driving signal PWM.

As shown in FIG. 8B, the control signal ON is a pulse signal. When the control signal ON has a high level, the trigger 810 is set according to the control signal ON, such that the driving signal PWM has a high level. When the ramp signal RAMP increases to the level of the reference signal 734, the trigger 810 is reset according to the comparison result, such that the driving signal PWM has a low level.

In one embodiment, the time duration T_{OFF} includes a first delay period T_{D1} and a second delay period T_{D2}. That is, the period T_{SW} of the driving signal PWM is equal to a sum of the time duration T_{ON}, the first delay period T_{D1}, and the second delay period T_{D2}, e.g., T_{SW}=T_{ON}+T_{D1}+T_{D2}.

In one embodiment, the first delay period T_{D1} is generated according to the fall time period T_{DOWN} and a delay time period T_{B}. More specifically, the first delay period T_{D1} is equal to the fall time period T_{DOWN} when the fall time period T_{DOWN} is greater than the delay time period T_{B}, and is equal to the delay time period T_{B} when the delay time period T_{B} is greater than the fall time period T_{DOWN}. Then, the second delay period T_{D2} is generated according to the time duration T_{ON} and the first delay period T_{D1}.

Similar to the description of FIG. 1B, the controller 704 modulates the time duration T_{ON} of the driving signal PWM, for example, the controller 704 controls the time duration T_{ON} to have a change rate γ, e.g., T_{ON}=T_{ON}_{_{—}}_{M}*(1+γ), where T_{ON}_{_{—}}_{M} represents a predetermined basic time duration for the driving signal PWM to be at the high level. In one embodiment, the controller 704 further modulates the delay time period T_{B} to have the change rate γ, e.g., T_{B}=T_{B}_{_{—}}_{M}*(1+γ), where T_{B}_{_{—}}_{M} represents a predetermined (e.g., user-specified) length of the delay time period T_{B}. In one embodiment, the controller 704 further sets the second delay period T_{D2} to satisfy T_{D2}=γ*(T_{ON}+T_{D1}).

Therefore, when the fall time period T_{DOWN} is greater than the delay time period T_{B}, then T_{D1}=T_{DOWN}, and the equation (18) is shown according to the equation (4):

$$\begin{matrix}{T}_{ON} + {T}_{D 1} = {T}_{ON} + {T}_{DOWN} \\ = {V}_{REC} / {V}_{OUT} * {T}_{ON} \\ = {V}_{REC} / {V}_{OUT} * {T}_{ON\_M} * ( 1 + γ ) .\end{matrix}$$

Thus, the period T_{SW} can be given by the equation (19):

$$\begin{matrix}{T}_{SW} = {T}_{ON} + {T}_{D 1} + {T}_{D 2} \\ = ( 1 + γ ) * ( {T}_{ON} + {T}_{D 1} ) \\ = {V}_{REC} / {V}_{OUT} * {T}_{ON\_M} * {( 1 + γ )}^{2} .\end{matrix} \qquad ( 19 )$$

Therefore, T_{ON}²/T_{SW} can be given by the equation (20):

T_{ON}²/T_{SW}=V_{OUT}/V_{REC}*T_{ON}_{_{—}}_{M}. (20)

When the delay time period T_{B} is greater than the fall time period T_{DOWN}, T_{D1}=T_{B}, and the equation (21) is shown:

T_{ON}+T_{D1}=T_{ON}+T_{B}=(T_{ON}_{_{—}}_{M}+T_{B}_{_{—}}_{M})*(1+γ) (21)

Thus, the period T_{SW} can be given by the equation (22):

$$\begin{matrix}{T}_{SW} = {T}_{ON} + {T}_{D 1} + {T}_{D 2} \\ = ( 1 + γ ) * ( {T}_{ON} + {T}_{D 1} ) \\ = ( {T}_{ON\_M} + {T}_{B\_M} ) * {( 1 + γ )}^{2} .\end{matrix} \qquad ( 22 )$$

Therefore, T_{ON}²/T_{SW} can be given by the equation (23):

T_{ON}²/T_{SW}=T_{ON}_{_{—}}_{M}²/(T_{ON}_{_{—}}_{M}+T_{B}_{_{—}}_{M}). (23)

Advantageously, the switching frequency of the switch 706 is modulated as the period T_{SW} of the driving signal changes. Therefore, EMC of the driving circuit 700 is improved. Furthermore, the controller 704 sets the time duration T_{ON}, the first delay period T_{D1}, and the second delay period T_{D2}, such that, in whichever the situation, quotients of the time duration T_{ON} squared and the period T_{SW} in subsequent periods are independent of the change rate γ of the time duration T_{ON}. As a result, according to the equation (17), the average current I_{L,A} through the LED light source 118 will not change as the period T_{SW} and the time duration T_{ON} change. Therefore, flickering of the LED light source 118 is avoided and the stability of the driving circuit 700 is enhanced.

FIG. 9A illustrates a block diagram of a signal generator (e.g., the signal generator 802), in an embodiment according to the present invention. FIG. 9A is described in combination with FIG. 8A and FIG. 8B.

In the embodiment in FIG. 9A, the signal generator 802 includes a first delay module 902, a second delay module 904, and a ramp generator 906. In one embodiment, the first delay module 902 receives the detection signal ZCDO, the current signal I_{COMP} and the driving signal PWM, and provides a first switch control signal 936 and a second switch control signal 938, accordingly. The first switch control signal 936 and the second switch control signal 938 indicate the first delay period T_{D1}. The second delay module then generates the second delay period T_{D2}, and accordingly controls the control signal ON. The ramp generator 906 generates the ramp signal RAMP according to the driving signal PWM, in one embodiment.

In one embodiment, the first delay module 902 includes a delay generator 908, an AND gate 910, and a trigger 926. The delay generator 908 further includes a constant delay generator 912, an inverting delay generator 914, and an AND gate 916. In one embodiment, the constant delay generator 912 generates a constant delay signal 918 indicating a delay time T_{B2} according to the driving signal PWM and the current signal I_{COMP}. The inverting delay generator 914 generates an inverting delay signal 920 indicating a delay time T_{B1} according to the driving signal PWM. The AND gate 916 provides a delay signal 922 indicating the delay time period T_{B} according to the constant delay signal 918 and the inverting delay signal 920. The AND gate 910 receives the delay signal 922 and the detection signal ZCDO indicating the fall time period T_{DOWN}, and controls the trigger 926 to generate the first switch control signal 936 and the second switch control signal 938 which indicate the first delay period T_{D1}. The operation of the first delay module 902 will be further described in relation to FIG. 10A.

In one embodiment, the second delay module 904 includes a switch S1, a jitter generator 928, and an output circuit 930, and also a current source 948, a switch S2, and a capacitor C1 coupled in series. The switch S1 and S2 are alternately turned on and off according to the first switch control signal 936 and the second switch control signal 938, respectively, so as to control charging and discharging of the capacitor C1. The output circuit 930 includes a comparator 932 and a trigger 934. The comparator 932 receives the voltage V_{C1} across the capacitor C1, and compares the voltage V_{C1} and a reference voltage V_{REF1} to generate a trigger signal 940 according to a comparison result. The trigger 934 receives the trigger signal 940, and accordingly generates the control signal ON. The operation of the second delay module 904 will be further described in relation to FIG. 10B.

In one embodiment, the ramp generator 906 includes a pair of switches S3 and S4, a capacitor C2, a current source 950, an inverter gate 942, and a jitter generator 944. The ramp generator 906 receives the driving signal PWM, and controls the switch S3 and S4 according to the driving signal PWM to control charging and discharging of the capacitor C2. In one embodiment, the capacitor C2 is used to provide the ramp signal RAMP.

As shown in FIG. 8B, the time duration T_{ON} of the driving signal PWM is equal to a rise time T_{UP} for the ramp signal RAMP to rise from the valley value V_{N} to a level equal to the reference signal 734 (the peak value V_{P}). Thus, a change rate of the rising rate of the ramp signal RAMP determines a change rate of the time duration T_{ON}. In one embodiment, the time duration T_{ON} has a change rate of γ.

In operation, when the driving signal PWM has a high level, the switch S3 is turned on and the switch S4 is turned off. As such, the current I_{C2} charges the capacitor C2 and accordingly the ramp signal RAMP rises. When the driving signal PWM has a low level, the switch S3 is turned off and the switch S4 is turned on. The capacitor C2 is discharged and accordingly the ramp signal RAMP falls. In one embodiment, the current I_{C2} determines the rising rate of the ramp signal RAMP. More specifically, the current I_{C2} is inversely proportional to the rise time T_{UP}. Similar to the description in FIG. 3, if γ is set to a relatively small value, the rise time T_{UP} has a change rate of γ by setting the charging current I_{C2} with a change rate of −γ, such that the change rate of the time duration T_{ON} is equal to γ, satisfying T_{ON}=T_{ON}_{_{—}}_{M}*(1+γ).

In one embodiment, the ramp generator 906 merges a current I_{REF2} flowing from the current source 950 and a jitter current I_{J3} flowing from the jitter generator 944 to generate the charging current I_{C2}; that is, the charging current I_{C2} equals a sum of the current I_{REF2} and the jitter current I_{J3}, where the current I_{REF2} has a constant current level and the jitter current I_{J3} has different current levels in different time periods of the driving signal PWM, such that the charging current I_{C2} have different current levels in different time periods of the driving signal PWM. Thus, the jitter current I_{J3} determines the change rate of the charging current I_{C2}. In one embodiment, by setting the jitter current I_{J3} equal to the current I_{REF2} multiplied by the change rate −γ, e.g., I_{J3}=(−γ)*I_{REF2}, the charging current I_{C2} has a change rate of −γ. Specifically, when the change rate γ has a positive value, it indicates that the directions of the jitter current I_{J3} and the current I_{REF2} are opposite, that is, the charging current I_{C2} is less than the current I_{REF2}. When the change rate γ has a negative value, it indicates that the directions of the jitter current I_{J3} and the current I_{REF2} are the same, that is, the charging current I_{C2} is greater than the current I_{REF2}. The operation of the jitter generator 944 will be further described in relation to FIG. 11.

FIG. 9B illustrates an example of a constant delay generator (e.g., the constant delay generator 912), in an embodiment according to the present invention.

In the example in FIG. 9B, the constant delay generator 912 includes a transistor 960 and a capacitor C3 coupled in parallel, a comparator 962, and the jitter generator 944. In one embodiment, the transistor 960 is controlled by the driving signal PWM, and is conducted on or off to discharge or charge the capacitor C3. For example, the capacitor C3 is charged by the current I_{COMP} and the jitter current Iₙ generated by the jitter generator 944 when the transistor 960 is conducted off. The comparator 962 compares a voltage V_{C3} across the capacitor C3 with a reference voltage V_{REF3}, so as to provide the constant delay signal 918. The operation of the constant delay generator 912 will be further described in relation to FIG. 10A.

FIG. 10A illustrates waveforms 1000 of signals received or generated by a delay module (e.g., the first delay module 902), in an embodiment according to the present invention. FIG. 10A is described in combination with FIGS. 9A and 9B. FIG. 10A shows the driving signal PWM, the inverting delay signal 920, a voltage signal V_{C3}, the constant delay signal 918, the delay signal 922, the detection signal ZCDO, and the first switch control signal 936.

As shown in FIG. 10A, during the time duration T_{ON} (e.g., from T₁ to T₃, or from T₇ to T₉), the driving signal PWM has a first state (e.g., a high level). During the time duration T_{OFF} (e.g., from T₃ to T₇), the driving signal PWM has a second state (e.g., a low level). In one embodiment, the inverting delay generator 914 generates the inverting delay signal 920 according to the driving signal PWM. More specifically, the driving signal PWM is switched to the high level from the low level at T₁, and the inverting delay signal 920 still has a high level at T₁. After a delay from T₁ to T₂, in response to the driving signal PWM, the inverting delay signal 920 is switched to a low level at T₂. Similarly, the driving signal PWM is switched to the low level from the high level at T₃, and the inverting delay signal 920 is switched to a high level at T₄ in response. Thus, the inverting delay signal 920 indicates an inverting delay time period T_{B1}. In the example in FIG. 10A, the inverting delay time period T_{B1} is equal to the time duration from T₃ to T₄.

The constant delay generator 912 generates the constant delay signal 918 according to the driving signal PWM and the current signal I_{COMP}. More specifically, when the driving signal PWM has a high level, e.g., from T₁ to T₃, the transistor 960 is conducted on to discharge the capacitor C3, as shown in FIG. 9B. The voltage signal V_{C3} across the capacitor C3 is less than the reference voltage V_{REF3}, so the comparator 962 outputs the constant delay signal 918 at a low level. When the driving signal PWM is switched to a low level at T₃, the transistor 960 is conducted off. A charging path is conducted for the capacitor C3 with a charging current of the current I_{COMP} and the jitter current I_{J3}. Thus, the voltage signal V_{C3} accordingly rises. When the voltage signal V_{C3} is still less than the reference voltage V_{REF3}, e.g., from T₃ to T₅, the constant delay signal 918 remains at a low level. When the voltage signal V_{C3} rises to the level of the reference voltage V_{REF3} at T₅, the comparator 962 switches the constant delay signal 918 to a high level. As such, the constant delay signal 918 indicates a constant delay time period T_{B2}. In the example of FIG. 10A, the constant delay time period T_{B2} is equal to the time duration from T₃ to T₅, which is greater than the inverting delay time period T_{B1}. In one embodiment, the constant delay time period T_{B2} is determined by the current signal I_{COMP}.

In one embodiment, the AND gate 916 determines which of the inverting delay time period T_{B1} and the constant delay time period T_{B2} is greater, and accordingly determines the delay time period T_{B}. For example, the delay time period T_{B} is equal to a greater delay time of the inverting delay time period T_{B1} and the constant delay time period T_{B2}. More specifically, when both the inverting delay signal 920 and the constant delay signal 918 have high levels at a specific time, the delay signal 922 is switched to a high level at that specific time. In the example of FIG. 10A, the constant delay time period T_{B2} is greater than the inverting delay time period T_{B1}, and both the inverting delay signal 920 and the constant delay signal 918 have high levels at T₅, thus, the delay signal 922 is switched to a high level at T₅. Therefore, the delay time period T_{B} is equal to the constant delay time period T_{B2}, e.g., the delay time period T_{B} is equal to the time duration from T₃ to T₅. In another embodiment, when the inverting delay time period T_{B1} is greater than the constant delay time period T_{B2}, the delay time period T_{B} is equal to the inverting delay time period T_{B1}.

Similarly, the AND gate 910 determines which of the delay time period T_{B} and the fall time period T_{DOWN} is greater, and accordingly generates the first switch control signal 936 and the second switch control signal 938 indicating the first delay period T_{D1}. In one embodiment, the first delay period T_{D1} is equal to a greater time value of the delay time period T_{B} and the fall time period T_{DOWN}. More specifically, during the fall time period T_{DOWN}, the current flowing through the LED light source 118 gradually decreases, and the detection signal ZCDO has a low level. At a specific time, the current drops to zero amperes and accordingly the detection signal ZCDO is switched to a high level. Thus, when both the delay signal 922 and the detection signal ZCDO have high levels at that specific time, the delay signal 924 generated by the AND gate 910 indicating the first delay period T_{Di} is switched to a high level and triggers the trigger 926 to generate the first switch control signal 936 with a high level. In the example of FIG. 10A, the fall time period T_{DOWN} is greater than the delay time period T_{B}. During fall time period T_{DOWN} from T₃ to T₆, the detection signal ZCDO has a low level. At time T₆, the detection signal ZCDO is switched to a high level. The delay signal 924 generated by the AND gate 910 is switched to a high level. The trigger 926 generates the first switch control signal 936 and the second switch control signal 938 according to the delay signal 924. Thus, the first delay period T_{D1} is equal to the fall time period T_{DOWN}, e.g., the first delay period T_{D1} is equal to the time duration from T₃ to T₆. In one embodiment, the second switch control signal 938 is opposite to the first switch control signal 936, e.g., the first switch control signal 936 is switched to a high level at T₆ while the second control signal 938 is switched to a low level.

FIG. 10B illustrates waveforms 1002 of signals received or generated by a delay module (e.g., the second delay module 904), in an embodiment according to the present invention. FIG. 10B is described in combination with FIGS. 9A and 9B and FIG. 10A. FIG. 10B shows the first switch control signal 936, a voltage V_{C1} across the capacitor C1, the control signal ON, and the driving signal PWM.

In one embodiment, from T₁ to T₆, the first switch control signal 936 has a low level and the second switch control signal 938 has a high level. Thus, the switch S1 is turned off according to the first switch control signal 936, and the switch S2 is turned on according to the second switch control signal 938. Accordingly, a current I_{REF1} flows from the current source 948 through the switch S2 to charge the capacitor C1. The voltage V_{C1} across the capacitor C1 increases. For example, the charging time for the capacitor C1 is equal to the time duration from T₁ to T₆; that is, the charging time equals a sum of the time duration T_{ON} and the first delay period T_{D1}. At T₆, the first switch control signal 936 is switched to a high level and the second switch control signal 938 is switched to a low level. Thus, the switch S1 is turned on according to the first switch control signal 936, and the switch S2 is turned off according to the second switch control signal 938. Accordingly, the capacitor C1 is discharged and the discharging current I_{J4} flow from ground via the capacitor C1 to the jitter generator 928. The voltage V_{C1} across the capacitor C1 decreases.

In one embodiment, the comparator 932 compares the voltage V_{C1} and the reference voltage V_{REF1} (e.g., zero volts). When the voltage V_{C1} drops to the level of the reference voltage V_{REF1} at T₇, the comparator 932 triggers the trigger 934 to generate the control signal ON. As shown in FIG. 10B, in one embodiment, the control signal ON is a pulse signal. Thus, the control signal ON is switched to the high level at T₇. The driving signal PWM is switched to the high level in response to the control signal ON. As described in FIG. 10A, the first switch control signal 936 then switches to the low level again, and the capacitor C1 is charged again. Therefore, the discharging time for the capacitor C1 is equal to the time duration from T₆ to T₇, which is proportional to the charging time. In one embodiment, the second delay period T_{D2} equals the discharging time of the capacitor C1; that is, the second delay period T_{D2} is proportional to the sum of the time duration T_{ON} and the first delay period T_{D1}.

In one embodiment, the current I_{REF1} and the current I_{J4} (which is adjusted according to the control signal ON) determine the charging time period (T_{ON}+T_{D1}) and the discharging time period (T_{D2}) of the capacitor C1, respectively. Specifically, the current I_{REF1} and the current I_{J4} are inversely proportional to the charging time and the discharging time of the capacitor C1, respectively. By setting the current I_{J4} equal to a result of the current I_{REF1} divided by γ, e.g., I_{J4}=I_{REF1}/γ, the discharging time equals γ times the charging time, satisfying T_{D2}=γ*(T_{ON}+T_{D1}). The operation of the jitter generator 928 will be further described in relation to FIG. 12.

FIG. 11 illustrates a diagram of a jitter generator (e.g., the jitter generator 944), in an embodiment according to the present invention. FIG. 11 is described in combination with FIG. 4, FIG. 5 and FIGS. 9A and 9B. In the embodiment of FIG. 11, the change rate γ makes regular changes in different periods of the driving signal PWM, e.g., the change rate γ increases progressively in adjacent periods.

In one embodiment, the jitter generator 944 includes a jitter generating module 1102, a trigger 1104, and a current source 1106. In one embodiment, the trigger 1104 receives the control signal ON. Similar to the description in FIG. 5, the trigger 1104 generates the jitter signals J5, J6, and J7 according to the control signal ON. The current source 1106 provides a current I_{REF3} proportional to the reference current I_{REF2} to the jitter generating module 1102. The jitter generating module 1102 generates the jitter current I_{J3} according to the jitter signals J5, J6, and J7.

In the embodiment of FIG. 11, the jitter generating module 1102 includes transistors M₄, M₅, M₆, and M₇ coupled in parallel, and switches S₅, S₆, and S₇ coupled in series to the transistors M₅ to M₇, respectively. The transistors M₅ to M₇ constitute multiple current mirrors with M₄, for generating the current I_{PRE5}, I_{PRE6}, and I_{PRE7}, respectively. The conductance status of the switches S₅ to S₇ is controlled by the jitter signals J5 to J7, such that the jitter current I_{J3} is generated accordingly. The relationship between the jitter current I_{J3} and the jitter signals J5 to J7 is similar to the relationship between the first jitter current I_{J1} and the jitter signals J1 to J3 as described in Table 3, to satisfy I_{J3}=(−γ)*I_{REF2}. However, the jitter generator 944 can have other configurations and is not limited to the example in FIG. 11.

FIG. 12 illustrates a diagram of a jitter generator (e.g., the jitter generator 928), in an embodiment according to the present invention. FIG. 12 is described in combination with FIG. 5 and FIGS. 9A and 9B.

In one embodiment, the jitter generator 928 includes a jitter generating module 1202, a trigger 1204, and a current source 1206. Similarly, the trigger 1204 receives the control signal ON, and generates the jitter signals J9, J10, and J11 according to the control signal ON. The current source 1206 generates a current I_{REF4} proportional to the reference current I_{REF1}. The jitter generating module 1202 receives the reference current I_{REF4}, and generates the current I_{J4} according to the jitter signals J9, J10, and J11 to satisfy I_{J4}=I_{REF1}/γ. As such, the current I_{J4} has different current levels during different time periods of the driving signal PWM.

In the embodiment of FIG. 12, the jitter generating module 1202 includes transistors M₈, M₉, M₁₀, and M₁₁ coupled in parallel, and switches S₉, S₁₀, and S₁₁ coupled in series to the transistors M₉ to M₁₁, respectively. The transistors M₉ to M₁₁ constitute multiple current mirrors with M_{g}, respectively, for generating the current I_{PRE9}, I_{PRE10}, and I_{PRE11}. The conductance status of the switches S₉ to S₁₁ is controlled by the jitter signals J9 to J11, such that the current i_{J4} is generated accordingly. Take the switch S₉ for example: if J9 has a high level (represented by logic 1), the switch S₉ is turned off; if J9 has a low level (represented by logic 0), the switch S₉ is turned on. The switches S₁₀ and S₁₁ operate similarly as S₉. In one embodiment, the relationship between the jitter current I_{J4} and the jitter signals J9, J10, and J11 is illustrated in Table 4.

TABLE 4

| J9J10J11 | I_{J4} |
|---|---|
| 000 | I_{PRE9} + I_{PRE10} + I_{PRE11} |
| 001 | I_{PRE9} + I_{PRE10} |
| 010 | I_{PRE9} + I_{PRE11} |
| 011 | I_{PRE9} |
| 100 | I_{PRE10} + I_{PRE11} |
| 101 | I_{PRE10} |
| 110 | I_{PRE11} |
| 111 | 0 |

In one embodiment, similar to the description in FIG. 5, the binary value J9J10J11 has eight different states in eight adjacent periods of the control signal ON. As such, the switches S₉, S₁₀, and S₁₁ have eight conductance statuses. Accordingly, the jitter current I_{J4} has eight different current levels in these eight adjacent periods. More specifically, when J9J10J11 has a value of 000, 001, 010, 011, 100, 101, 110, and 111, the jitter current I_{J4} is equal to I_{PRE9}+I_{PRE10}+I_{PRE11}, I_{PRE9}+I_{PRE10}, I_{PRE9}+I_{PRE11}, I_{PRE9}, I_{ORE10}+I_{PRE11}, I_{PRE10}, I_{PRE11}, and 0, respectively. In one embodiment, the settings of the currents I_{PRE9}, I_{PRE10}, and I_{PRE11} satisfy I_{PRE9}>I_{PRE10}+I_{PRE11}>I_{PRE10}>I_{PRE11}, e.g., I_{PRE9}=4 uA, I_{PRE10}=2 uA, and I_{PRE11}=1 uA. Thus, the jitter current I_{J4} decreases in these eight periods. However, the jitter generator 928 can have other configurations and is not limited to the example in FIG. 12.

FIG. 13 illustrates a flowchart 1300 of examples of operations performed by a circuit for driving an LED light source, e.g., the circuit 700. FIG. 13 is described in combination with FIG. 7A to FIG. 12. Although specific steps are disclosed in FIG. 13, such steps are examples. That is, the present invention is well suited to performing various other steps or variations of the steps recited in FIG. 13.

In block 1302, an input voltage (e.g., the rectified voltage V_{REC}) is converted to an output voltage (e.g., the output voltage V_{OUT}) based on a conductance status of a switch (e.g., the switch 706) to power a light source (e.g., the LED light source 118).

In block 1304, a driving signal (e.g., the driving signal PWM) is generated to control the conductance status of the switch on and off alternately to control a current through the light source. In one embodiment, the driving signal is a periodic signal having a first state (e.g., a high level) in a first time duration (e.g., the time duration T_{ON}) and having a second state (e.g., a low level) in a second time duration (e.g., the first delay period T_{D1}) and in a third time duration (e.g., the second delay period T_{D2}) per period of the driving signal (e.g., the period T_{SW}). The switch is turned on when the driving signal operates in the first state, and is turned off when the driving signal operates in the second state.

In one embodiment, a reference signal (e.g., the reference signal 734) is received. A control signal (e.g., the control signal ON) and a ramp signal (e.g., the ramp signal RAMP) are generated. The ramp signal ramps up and down periodically. The ramp signal is compared with the reference signal. The driving signal is switched to the first state in response to the control signal, and is switched to the second state according to a result of the comparison of the ramp signal and the reference signal.

In block 1306, the first time duration and the second time duration are modulated to have a first change rate (e.g., the change rate γ). In one embodiment, a rising rate of the ramp signal is regulated to modulate the first time duration. In one embodiment, the second time duration is determined by a fourth time duration (e.g., the fall time period T_{DOWN}) for the current to drop to a predetermined level. In an alternative embodiment, a first delay signal (e.g., the delay signal 922) indicating a fifth time duration (e.g., the delay time period T_{B}) is generated according to the reference signal. The second time duration is determined by both the fifth time duration and the fourth time duration for the current to drop to the predetermined level.

In block 1308, the third time duration is modulated so that it is equal to a product of the first change rate and a sum of the first time duration and the second time duration, e.g., T_{D2}=γ*(T_{ON}+T_{D1}), such that a quotient of the first time duration squared and the period of the driving signal (e.g., T_{ON}²/T_{SW}) is independent of a change of the first time duration, and the current is independent of the change. In one embodiment, a first current (e.g., the current I_{REF1}) is conducted to charge an energy storage unit (e.g., the capacitor C1) during the first time duration and the second time duration. A first jitter current (e.g., the current I_{J4}) is conducted to discharge the energy storage unit during the third time duration. The first jitter current is equal to a result of the first current divided by the first change rate. A voltage signal (e.g., the voltage signal V_{C1}) is compared with a reference voltage (e.g., the reference voltage V_{REF1}) to provide the control signal.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A circuit comprising:
a converter configured to provide an output voltage to power a light source and comprising a switch, wherein said switch is turned on and off alternately according to a driving signal to control a current through said light source; and
a controller coupled to said converter and configured to generate said driving signal, wherein said driving signal is a periodic signal having a first state in a first time duration and having a second state in a second time duration and in a third time duration per period of said driving signal, wherein said switch is turned on when said driving signal operates in said first state and is turned off when said driving signal operates in said second state, and wherein said controller modulates said first time duration and said second time duration to have a first change rate, and modulates said third time duration equal to a product of said first change rate and a sum of said first time duration and said second time duration, such that a quotient of said first time duration squared and said period of said driving signal is independent of a change of said first time duration, and said current is independent of said change.

2. The circuit as claimed in claim 1, wherein said converter further comprises:
a sensor, configured to provide a sense signal indicating said current through said light source; and
a transformer having a primary winding and a secondary winding, wherein said secondary winding is configured to provide a current detection signal indicating whether said current decreases to a predetermined level.

3. The circuit as claimed in claim 2, wherein said controller comprises:
a sensing circuit, configured to receive said sense signal and said current detection signal, and to generate a detection output signal according to said current detection signal, wherein said detection output signal indicates a fourth time duration for said current to drop to said predetermined level, wherein said sensing circuit generates a reference signal according to said sense signal;
a signal generator, coupled to said sensing circuit and configured to generate a ramp signal and a control signal according to said detection output signal; and
an output circuit, coupled to said signal generator and configured to generate said driving signal according to said ramp signal, said reference signal, and said control signal,
wherein said signal generator regulates a rising rate of said ramp signal to modulate said first time duration, and controls said control signal to modulate said second time duration and said third time duration.

4. The circuit as claimed in claim 3, wherein said second time duration is determined by said fourth time duration.

5. The circuit as claimed in claim 3, wherein said sensing circuit is further configured to generate a current signal proportional to said reference signal, and wherein said signal generator is further configured to generate a first delay signal indicating a fifth time duration according to said current signal and said driving signal, and wherein said second time duration is determined by said fourth time duration and said fifth time duration.

6. The circuit as claimed in claim 5, wherein said second time duration is equal to said fourth time duration if said fourth time duration is greater than said fifth time duration, and is equal to said fifth time duration if said fourth time duration is less than said fifth time duration.

7. The circuit as claimed in claim 3, wherein said output circuit is configured to compare said ramp signal and said reference signal, and wherein said driving signal is switched to said first state in response to said control signal, and is switched to said second state according to a result of comparing said ramp signal and said reference signal.

8. The circuit as claimed in claim 3, wherein said signal generator comprises:
a ramp generator, configured to generate said ramp signal, wherein a second change rate of a rising rate of said ramp signal determines said first change rate of said first time duration;
a first delay module, configured to generate a switch control signal indicating said second time duration according to said detection output signal; and
a second delay module, coupled to said first delay module and configured to receive said switch control signal and to generate said third time duration.

9. The circuit as claimed in claim 8, wherein said first delay module comprises:
a delay generator, configured to generate a first delay signal indicating a fifth time duration according to said reference signal; and
a first gate, coupled to said delay generator and configured to receive said detection output signal and said first delay signal, and configured to generate said switch control signal indicating said second time duration according to said detection output signal and said first delay signal.

10. The circuit as claimed in claim 8, wherein said second delay module comprises:
a first energy storage unit, configured to provide a voltage signal, wherein a first current is conducted to charge said first energy storage unit during said first time duration and said second time duration, and a first jitter current is conducted to discharge said first energy storage unit during said third time duration, and wherein said first jitter current has different current levels during different periods of said driving signal; and
a comparator, configured to compare said voltage signal with a reference voltage and to provide said control signal.

11. The circuit as claimed in claim 10, wherein said first jitter current is equal to a result of said first current divided by said first change rate.

12. The circuit as claimed in claim 8, wherein said ramp generator comprises:
an energy storage unit, configured to provide said ramp signal, wherein a charging current is conducted to charge said energy storage unit when said driving signal operates in said first state, and wherein a discharging current is conducted to discharge said energy storage unit when said driving signal operates in said second state.

13. The circuit as claimed in claim 12, wherein said ramp generator generates a first current and a first jitter current, and merges said first current and said first jitter current to generate said charging current, wherein said first jitter current has different current levels during different periods of said driving signal.

14. A controller for controlling current to a light source, said controller comprising:
a signal generator configured to generate a ramp signal and a control signal; and
an output circuit coupled to said signal generator and configured to generate a driving signal according to said ramp signal and said control signal, wherein said driving signal is a periodic signal having a first state in a first time duration and having a second state in a second time duration and in a third time duration per period of said driving signal, and wherein a switch coupled to said controller is turned on when said driving signal operates in said first state and turned off when said driving signal operates in said second state to control a current through said light source,
wherein said controller modulates said first time duration and said second time duration to have a first change rate, and modulates said third time duration equal to a product of said first change rate and a sum of said first time duration and said second time duration, such that a quotient of said first time duration squared and said period of said driving signal is independent of a change of said first time duration, and said current is independent of said change.

15. The controller as claimed in claim 14, further comprising:
a sensing circuit configured to receive a sense signal indicating said current and to receive a current detection signal indicating whether said current decreases to a predetermined level, wherein said sensing circuit generates a reference signal according to said sense signal and generates a detection output signal according to said current detection signal,
wherein said signal generator generates said ramp signal and said control signal according to said detection output signal, and wherein said detection output signal indicates a fourth time duration for said current to drop to said predetermined level.

16. The controller as claimed in claim 15, wherein said second time duration is determined by said fourth time duration.

17. The controller as claimed in claim 15, wherein said sensing circuit is further configured to generate a current signal proportional to said reference signal, wherein said signal generator is further configured to generate a first delay signal indicating a fifth time duration according to said current signal, and wherein said second time duration is determined by said fourth time duration and said fifth time duration.

18. The controller as claimed in claim 15, wherein said output circuit is configured to compare said ramp signal and said reference signal, and wherein said driving signal is switched to said first state in response to said control signal, and is switched to said second state according to a result of comparing said ramp signal and said reference signal.

19. The controller as claimed in claim 15, wherein said signal generator comprises:
a ramp generator, configured to generate said ramp signal, wherein a second change rate of a rising rate of said ramp signal determines said first change rate of said first time duration;
a first delay module, configured to generate a switch control signal indicating said second time duration according to said detection output signal; and
a second delay module, coupled to said first delay module and configured to receive said switch control signal, and to conduct a first current to charge an energy storage unit during said first time duration and said second time duration, and to conduct a first jitter current to discharge said energy storage unit during said third time duration, wherein said first jitter current is equal to a result of said first current divided by said first change rate.

20. A method comprising:
converting an input voltage to an output voltage based on a conductance status of a switch to power a light source;
generating a driving signal to control said conductance status of said switch on and off alternately to control a current through said light source, wherein said driving signal is a periodic signal having a first state in a first time duration and having a second state in a second time duration and in a third time duration per period of said driving signal, wherein said switch is turned on when said driving signal operates in said first state, and is turned off when said driving signal operates in said second state;
modulating said first time duration and said second time duration to have a first change rate; and
modulating said third time duration equal to a product of said first change rate and a sum of said first time duration and said second time duration, such that a quotient of said first time duration squared and said period of said driving signal is independent of a change of said first time duration, and said current is independent of said change.

21. The method as claimed in claim 20, wherein said method further comprises:
receiving a reference signal;
generating a control signal and a ramp signal, wherein said ramp signal ramps up and down periodically;
switching said driving signal to said first state in response to said control signal;
comparing said ramp signal and said reference signal; and
switching said driving signal to said second state according to a result of said comparing.

22. The method as claimed in claim 21, wherein said method further comprises:
regulating a rising rate of said ramp signal to modulate said first time duration;
conducting a first current to charge an energy storage unit during said first time duration and said second time duration;
conducting a first jitter current to discharge said energy storage unit during said third time duration, wherein said first jitter current is equal to a result of said first current divided by said first change rate; and
comparing a voltage signal with a reference voltage to provide said control signal.

23. The method as claimed in claim 20, wherein said method further comprises:
determining said second time duration by a fourth time duration for said current to drop to a predetermined level.

24. The method as claimed in claim 20, wherein said method further comprises:
generating a first delay signal indicating a fifth time duration according to said reference signal; and
determining said second time duration by said fifth time duration and a fourth time duration for said current to drop to a predetermined level.
